(19) United States
(12) Patent Application Publication
(10) Pub. No.: US 2024/0267205 A1
(43) Pub. Date: Aug. 8, 2024

(54) GROUP DELEGATION COMPUTING METHOD

(71) Applicant: SOOCHOW UNIVERSITY, Suzhou (CN)

(72) Inventors: Xizhao LUO, Suzhou (CN); Chao ZHANG, Suzhou (CN); Zhengyan DING, Suzhou (CN)

(21) Appl. No.: 18/617,185

(22) Filed: Mar. 26, 2024

(51) Int. Cl. H04L 9/08; H04L 9/32

(52) U.S. Cl. CPC H04L 9/0825; H04L 9/3247

(57) ABSTRACT

A group delegation computing method includes: executing a key generation algorithm to obtain various types of keys; executing a member joining algorithm to implement a member joining function, combining customers with the same need into a group, and delegating a blinded delegation function to a cloud server; executing a question generation algorithm to generate a group signature and delegating a computing task to the cloud server; executing a signature verification algorithm to output a verification result; executing a computing algorithm only when a signature is valid to obtain a computing result and a correctness proof; executing a blind verification algorithm to verify whether the result; if the result is correct, executing a recovery algorithm; executing a member revocation algorithm to perform a member revocation function; and when there is a dispute over the delegation computing, executing an open algorithm to trace an identity of a specific member.

### TECHNICAL FIELD

The present invention relates to the technical field of group delegation computing, and specifically to a group delegation computing method.

### BACKGROUND

With the iteration of information technology, the amount of data that people need to process also increases explosively. In consideration of the amount of data that needs to be computed, the computing power of local users has become insufficient. The emergence of delegation computing solves the problem of limited client resources. A client can rent computing resources from a cloud server on a pay-as-you-go basis and delegate the computing tasks to the cloud server, thereby avoiding necessity of purchasing computing resources due to temporary needs and incurring expensive investment costs.

A general scheme of delegating computing of function F usually expects a client to run an expensive pre-processing stage in advance to generate a user key SK_{F} and a computing key CK_{F}, and then amortize the huge initial costs over multiple executions of the protocol ((F(xᵢ) is computed for different inputs xᵢ), but the client requires the key SK_{F} to start each time of execution. In other words, the client can delegate computing tasks to the cloud only when significant investment has been made in the pre-processing stage. This only makes sense if the client needs to delegate multiple different inputs on the same computing task. In order to use the amortization model to a greater extent, BryanParno and other people (2012) explicitly introduced the concept of public delegation for the first time and constructed a public delegation computing scheme based on attribute encryption, so that everyone can delegate computing tasks to the cloud. However, in this case, some delegators maliciously take advantage of the public delegation attribute to perform delegation tasks for free by using pre-processing that other customers have invested heavily in, which obviously violates the “pay-as-you-go” model of cloud computing.

### SUMMARY

In order to solve the disadvantage mentioned in background, the purpose of the present invention is to provide a group delegation computing method, to combine customers with a same computing task into a group, and delegate computing to a cloud service provider in the name of the group. After each delegator is authorized as a group member by the group administrator, the delegator can use group resources to delegate computing tasks to the cloud server, and anyone can verify, without knowing an input, whether a computing result returned by the cloud service provider is correct. The identity of the delegator is confidential, and only when a group member maliciously uses computing resources or there is a dispute over outsourced computing, the group administrator can trace the identity of the delegator.

The purpose of the present invention can be achieved by the following technical solution: A group delegation computing method, which includes the following steps:
receiving a security parameter and a number of group members, and inputting the security parameter and the number of group members into a pre-established trusted third-party operation initialization algorithm model, to obtain a public parameter and an initialized revocation list;
inputting the public parameter and a delegation function into a pre-established key generation algorithm model, to obtain a group administrator secret key, a group administrator public key, a trace secret key, a trace public key, a pair of a public key and a secret key of a group member, a group public key, a secret key for delegation computing, and a public key for delegation computing;
inputting the public parameter, the group administrator secret key, and the group public key into a pre-established member joining algorithm model, generating a digital signature by using a key pair registered in PKI, verifying whether the digital signature is registered, and if the digital signature is registered, terminating joining, or if the digital signature is not registered, computing a revocation token and a group member certificate;
inputting a delegation public key, a delegation secret key, the group public key, a group member secret key, a group member certificate, and a delegation input into a pre-established question generation algorithm model, to obtain an encrypted delegation input, a verification key, a computing key, a recovery key, and a group signature issued by a group member;
inputting the group public key, the revocation list, the delegation input, and the group signature into a pre-established signature verification algorithm model, performing signature verification on the group signature issued by the group member, to output a verification result, and if the signature is legal, returning 1, or if the signature is illegal, returning 0;
inputting the computing key, the encrypted delegation input, and the verification result into a computing algorithm model, and if the signature verification is illegal, skipping performing computing, or if the signature verification is legal, computing, by the cloud server, a computing result and a correctness proof;
inputting the delegation public key, the verification key, the computing result, and the correctness proof into a pre-established blind verification algorithm model, to obtain a blind verification result, and if the computing result is correct, returning acceptance, or if the computing result is incorrect, returning rejection;
inputting the recovery key, the blind verification result, and the computing result into a pre-established recovery algorithm model, and if an output of the blind verification result is acceptance, outputting a real function result, or if the output is rejection, terminating the algorithm;
inputting the group public key, the group administrator secret key, a revocation token of a group member, and a revocation list into a pre-established member revocation algorithm model, adding the revocation token of the group member to the revocation list to perform a revocation function of the group member, and if the revocation succeeds, returning 1, or if the revocation fails, returning 0; and
inputting the group public key, a trace key, the delegation input, and the group signature into a pre-established signature opening algorithm model, to obtain an opening result, and determining an identity of a specific member of the delegation computing.

Preferably, the trusted third-party operation initialization algorithm model inputs the security parameter λ∈ [symbol] , the number n∈ [symbol] of group members, outputs the public parameter pp, and initializes the revocation list to RL; the group administrator and the group member execute the key generation algorithm model and output the group administrator secret key gmsk, the trace secret key gtsk, the group administrator public key gmpk, the trace public key gtpk, a pair (uskᵢ, upkᵢ) of a public key and a secret key of a group member i, a group public key gpk:=(pp, gmpk, gtpk, upkᵢ), the public key PK_{F} for delegation computing, and the secret key SK_{F} for delegation computing; the group administrator executes the member joining algorithm model and outputs a member certificate cert; and a revocation token regᵢ of the group member i; the group member executes the question generation algorithm model and outputs a group signature τₓ, an encryption delegation input σₓ, a verification key VKₓ, a computing key CK_{F} of the cloud server, and a recovery key RK_{F}; the verifier executes the signature verification algorithm and outputs a signature verification result T indicating whether the group signature is legal; the cloud service provider executes the computing algorithm model when the signature verification is legal, and outputs the computing result σ_{y} and the correctness proof π; and any third party executes the blind verification algorithm model and outputs a blind verification result T_{σy} indicating whether the computing result of the cloud service provider is correct.

Preferably, a process of outputting different results by the recovery algorithm model according to different blind verification results is as follows:
inputting the delegation public key PK_{F}, the verification key VKₓ, the computing result oy, and the correctness proof π, and if the blind verification result T_{σy}=(1, accept, S), outputting a real computing result y=F (x), or if the blind verification result T_{σy}=(1, reject, S), outputting ⊥.

Preferably, a process of executing the member revocation algorithm by the group administrator is as follows:
the group administrator inputs the group public key gpk, the group administrator secret key gmsk, the group member revocation token regᵢ, and the revocation list RL, and adds the revocation token to the revocation list RL, updates and publishes the revocation list including regᵢ, and if the revocation succeeds, outputs 1, or if the revocation fails, outputs 0.

Preferably, a process of executing the signature opening algorithm model and outputting different results by the group administrator is as follows:
inputting the group public key gpk, the group administrator secret key gmsk, the delegation input x, and the group signature τₓ, and if the signature is opened successfully, outputting a specific identity of a delegator, or if the signature is opened unsuccessfully, outputting 1.

Preferably, the group delegation computing method satisfies the correctness as follows:
for ∀F∈ [symbol] , ∀x∈Dom(F) and ∀λ, n∈ [symbol] , i∈[n], both of the following conditions are true:
1. if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GUJoin(pp, gmsk, gpk)→(certᵢ, regᵢ), and GProbGen(PK_{F}, SK_{F}, gpk, uskᵢ, certᵢ, x)→(σₓ, τₓ, VKₓ, CK_{F}, RK_{F}), GVerify(gpk, x, τₓ)→T=1 and GOpen(gpk, gtsk, x, τₓ)→i are true, and this indicates that a signature generated by a legal group member by executing the signature algorithm needs to be correctly verified and opened; and
2. if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GProbGen(PK_{F}, SK_{F}, gpk, uskᵢ, certᵢ, x)→(σₓ, τₓ, VKₓ, CK_{F}, RK_{F}) and GCompute(CK_{F}, σₓ)→(σ_{y}, π), Pr[BVerify(PK_{F}, VKₓ, σ_{y}, π)→T_{σ}_{_{y}}=(1, accept, S)]=1 is true, and this indicates that if the cloud service provider performs the GCompute algorithm honestly, the verification algorithm returns acceptance at the probability 1.

Preferably, the group delegation computing method satisfies the verifiability as follows: a dishonest cloud service provider or a malicious adversary cannot forge an incorrect result that can pass the blind verification algorithm, and cannot trick a user and a verifier into accepting an incorrect computing result.

Preferably, the group delegation computing method satisfies anonymity as follows: it is required that when a group signature is provided, no one other than the group administrator [symbol] can determine a real identity of a signer only based on the signature. Preferably, the group delegation computing method satisfies traceability as follows: if the verifier has dispute over the reliability of the signature, the group administrator searches a storage list through the signature opening algorithm, to find identity information of the signer.

According to another aspect of the present invention, in order to achieve the above objective, a device is disclosed, including:
one or more processors; and
a memory, configured to store one or more programs; where
the one or more programs, when executed by the one or more processors, cause the one or more processors to implement the group delegation computing method as described above.

The present invention has the following beneficial effects:

The present invention can reduce costs, improve scalability, enhance security and improve resource utilization. First, the present invention reduces costs by enabling customers to jointly purchase cloud services, thereby lowering the overall investment required. Second, the present invention provides customers with access to industry-specific cloud platforms that cater exactly to their unique needs. Third, the present invention ensures data privacy and the identity privacy of the delegator. Finally, the present invention promotes the efficient usage of computing resources, maximizes computing resource saving, and prevents malicious usage by the delegator, and is more in line with the pay-as-you-go model of cloud computing.

### BRIEF DESCRIPTION OF THE DRAWINGS

In order to more clearly describe the technical solutions in the embodiments of the present invention or in the prior art, the drawings required for describing the embodiments or the prior art will be briefly described below. Apparently, those of ordinary skill in the art may still derive other drawings from these drawings without creative work.

FIG. 1 is a schematic flowchart of a method according to the present invention;

FIG. 2 is a diagram of an adversary attack experimental algorithm for verifiability according to the present invention;

FIG. 3 is a diagram of adversary attack experimental steps for anonymity according to the present invention; and

FIG. 4 is a diagram of adversary attack experimental steps for traceability according to the present invention.

### DETAILED DESCRIPTION

The following clearly and completely describes the technical solutions in the embodiments of the present invention with reference to the accompanying drawings in the embodiments of the present invention. Apparently, the described embodiments are some of the embodiments of the present invention rather than all of the embodiments. All other embodiments obtained by a person of ordinary skill in the art based on the embodiments of the present invention without creative efforts shall fall within the protection scope of the present invention.

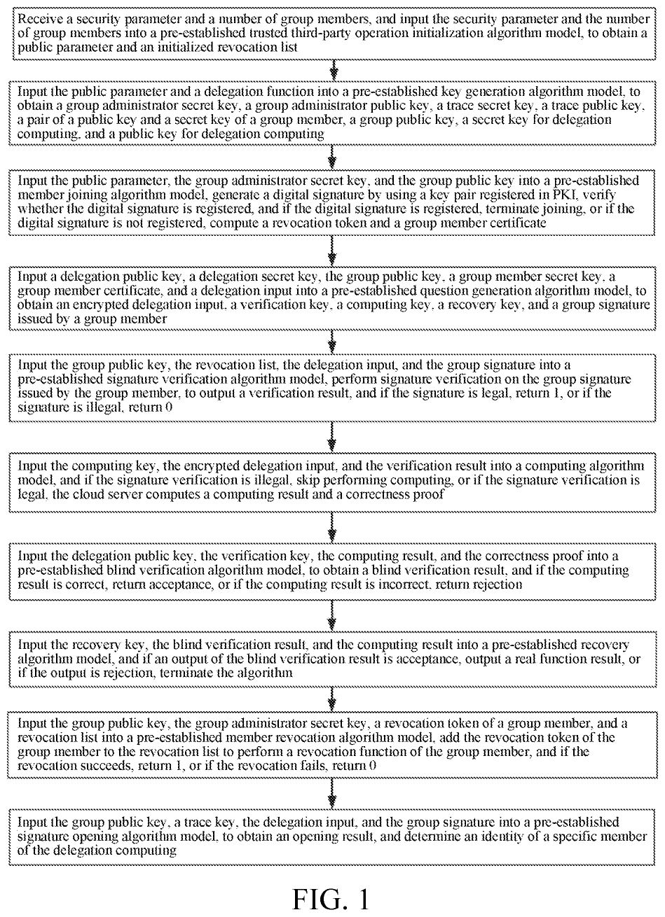

FIG. 1 shows a group delegation computing method. The method includes the following steps:
receiving a security parameter and a number of group members, and inputting the security parameter and the number of group members into a pre-established trusted third-party operation initialization algorithm model, to obtain a public parameter and an initialized revocation list;
inputting the public parameter and a delegation function into a pre-established key generation algorithm model, to obtain a group administrator secret key, a group administrator public key, a trace secret key, a trace public key, a pair of a public key and a secret key of a group member, a group public key, a secret key for delegation computing, and a public key for delegation computing;
inputting the public parameter, the group administrator secret key, and the group public key into a pre-established member joining algorithm model, generating a digital signature by using a key pair registered in PKI, verifying whether the digital signature is registered, and if the digital signature is registered, terminating joining, or if the digital signature is not registered, computing a revocation token and a group member certificate;
inputting a delegation public key, a delegation secret key, the group public key, a group member secret key, a group member certificate, and a delegation input into a pre-established question generation algorithm model, to obtain an encrypted delegation input, a verification key, a computing key, a recovery key, and a group signature issued by a group member;
inputting the group public key, the revocation list, the delegation input, and the group signature into a pre-established signature verification algorithm model, performing signature verification on the group signature issued by the group member, to output a verification result, and if the signature is legal, returning 1, or if the signature is illegal, returning 0;
inputting the computing key, the encrypted delegation input, and the verification result into a computing algorithm model, and if the signature verification is illegal, skipping performing computing, or if the signature verification is legal, computing, by the cloud server, a computing result and a correctness proof;
inputting the delegation public key, the verification key, the computing result, and the correctness proof into a pre-established blind verification algorithm model, to obtain a blind verification result, and if the computing result is correct, returning acceptance, or if the computing result is incorrect, returning rejection;
inputting the recovery key, the blind verification result, and the computing result into a pre-established recovery algorithm model, and if an output of the blind verification result is acceptance, outputting a real function result, or if the output is rejection, terminating the algorithm;
inputting the group public key, the group administrator secret key, a revocation token of a group member, and a revocation list into a pre-established member revocation algorithm model, adding the revocation token of the group member to the revocation list to perform a revocation function of the group member, and if the revocation succeeds, returning 1, or if the revocation fails, returning 0; and
inputting the group public key, a trace key, the delegation input, and the group signature into a pre-established signature opening algorithm model, to obtain an opening result, and determining an identity of a specific member of the delegation computing.

In this embodiment, the trusted third-party operation initialization algorithm model inputs the security parameter λ∈ [symbol] , the number n∈ [symbol] of group members, outputs the public parameter pp, and initializes the revocation list to RL. The group administrator and the group member execute the key generation algorithm model and output the group administrator secret key gmsk, the trace secret key gtsk, the group administrator public key gmpk, the trace public key gtpk, a pair (uskᵢ, upkᵢ) of a public key and a secret key of a group member i, a group public key gpk:=(pp, gmpk, gtpk, upkᵢ), the public key PK_{F} for delegation computing, and the secret key SK_{F} for delegation computing. The group administrator executes the member joining algorithm model and outputs a member certificate cert; and a revocation token regᵢ of the group member i. The group member executes the question generation algorithm model and outputs a group signature τₓ, an encryption delegation input σₓ, a verification key VKₓ, a computing key CK_{F} of the cloud server, and a recovery key RK_{F}. The verifier executes the signature verification algorithm and outputs a signature verification result T indicating whether the group signature is legal. The cloud service provider executes the computing algorithm model when the signature verification is legal, and outputs the computing result oy and the correctness proof T. Any third party executes the blind verification algorithm model and outputs a blind verification result T_{σy} indicating whether the computing result of the cloud service provider is correct.

In this embodiment, a process of executing the recovery algorithm model by the delegator to output different results according to different blind verification results is as follows: inputting the delegation public key PK_{F}, the verification key VKₓ, the computing result σ_{y}, and the correctness proof π, and if the blind verification result T_{σy}=(1, accept, S), outputting a real computing result y=F (x), or if the blind verification result T_{σy}=(1, reject, S), outputting ⊥.

In this embodiment, a process of executing the member revocation algorithm by the group administrator is as follows:

the group administrator inputs the group public key gpk, the group administrator secret key gmsk, the group member revocation token regᵢ, and the revocation list RL, and adds the revocation token to the revocation list RL, updates and publishes the revocation list including regᵢ, and if the revocation succeeds, outputs 1, or if the revocation fails, outputs 0.

In this embodiment, a process of executing the signature opening algorithm model and outputting different results by the group administrator is as follows:
inputting the group public key gpk, the group administrator secret key gmsk, the delegation input x, and the group signature τₓ, and if the signature is opened successfully, outputting a specific identity of a delegator, or if the signature is opened unsuccessfully, outputting L.

In this embodiment, the group delegation computing method satisfies the correctness as follows:
for ∀F∈ [symbol] , ∀x∈Dom(F) and ∀λ, n∈ [symbol] , i∈[n], both of the following conditions are true:
1. if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GUJoin(pp, gmsk, gpk)→(certᵢ, regᵢ), and GProbGen(PK_{F}, SK_{F}, gpk, uskᵢ, certᵢ, x)→(σₓ, τₓ, VKₓ, CK_{F}, RK_{F}), GVerify(gpk, x, τₓ)→T=1 and GOpen(gpk, gtsk, x, τₓ)→i are true, and this indicates that a signature generated by a legal group member by executing the signature algorithm needs to be correctly verified and opened; and
2. if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GProbGen(PK_{F}, SK_{F}, gpk, uskᵢ, certᵢ, x)→(σₓ, τₓ, VKₓ, CK_{F}, RK_{F}), and GCompute(CK_{F}, σₓ)→(σ_{y}, π), Pr[BVerify(PK_{F}, VKₓ, σ_{y}, π)→T_{σ}_{_{y}}=(1, accept, S)]=1 is true, and this indicates that if the cloud service provider performs the GCompute algorithm honestly, the verification algorithm returns acceptance at the probability 1.

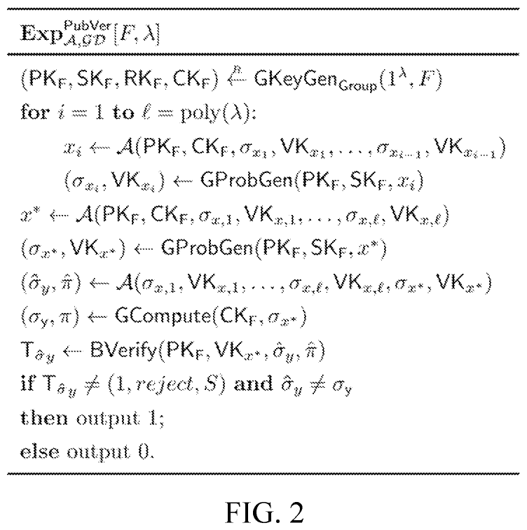

Finally, it should be noted that the group delegation computing method satisfies verifiability as follows:
a dishonest cloud service provider or a malicious adversary cannot forge an incorrect result that can pass the blind verification algorithm, and cannot trick a user and a verifier into accepting an incorrect computing result. This requirement is first formalized through experiment 1 (shown in FIG. 2), where poly(.) represents a polynomial. In the experiment, the goal of the adversary [symbol] is to generate a fake incorrect computing result to pass a blind verification algorithm.

In this embodiment, For any λ∈ [symbol] and any function F∈ [symbol] , the adversary [symbol] can access an oracle machine for q=poly(n) times at most in experiment 1. The advantage probability of the adversary [symbol] is expressed as follows:

$${Adv}_{𝒜 , 𝒢𝒟}^{PubVer} [ F , λ ] = Pr [ {Exp}_{𝒜 , 𝒢𝒟}^{PubVer} [ F , λ ] = 1 ]$$

For a type of function [symbol] , if the probability Ad [symbol] (F, λ) is negligible for ∀F∈ [symbol] and any probabilistic polynomial time adversary [symbol] , the group delegation computing scheme is verifiable.

It should be noted that the group delegation computing method satisfies anonymity as follows:
it is required that when a group signature is provided, no one other than the group administrator [symbol] can determine a real identity of a signer only based on the signature.

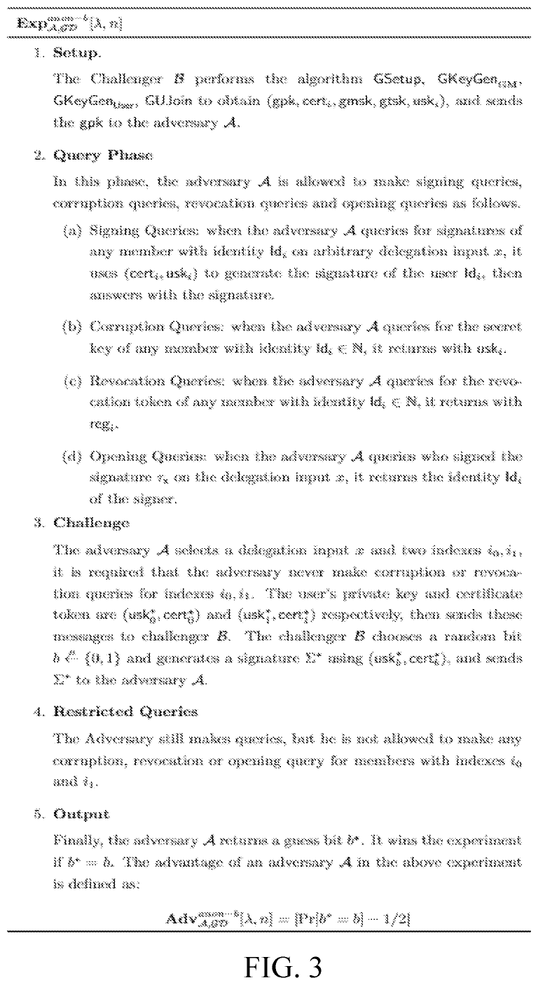

In this embodiment, before defining anonymity in detail, experiment 2 between the adversary [symbol] and the challenger [symbol] is first introduced (as shown in FIG. 3). In the experiment, the goal of the adversary [symbol] is to determine, from two adaptively chosen keys, a key used to generate a signature. More precisely, [symbol] generates two challenge users i₀ and i₁, then [symbol] randomly selects a bit b∈{0, 1} and signs with a secret key of i_{b}, and finally [symbol] returns a guess b*. The advantage probability of the adversary [symbol] is expressed as follows:

$${Adv}_{𝒜 , 𝒢𝒟}^{anon - b} [ λ - n ] = \vert Pr [ {b}^{*} = b ] - 1 / 2 \vert$$

If the probability Ad [symbol] [λ, n] is negligible for any probabilistic polynomial time adversary [symbol] , the group delegation computing scheme is anonymous.

It should be noted that the group delegation computing method satisfies traceability as follows:
if the verifier has dispute over the reliability of the signature, the group administrator may search a storage list through the signature opening algorithm, to find identity information of a specific signer.

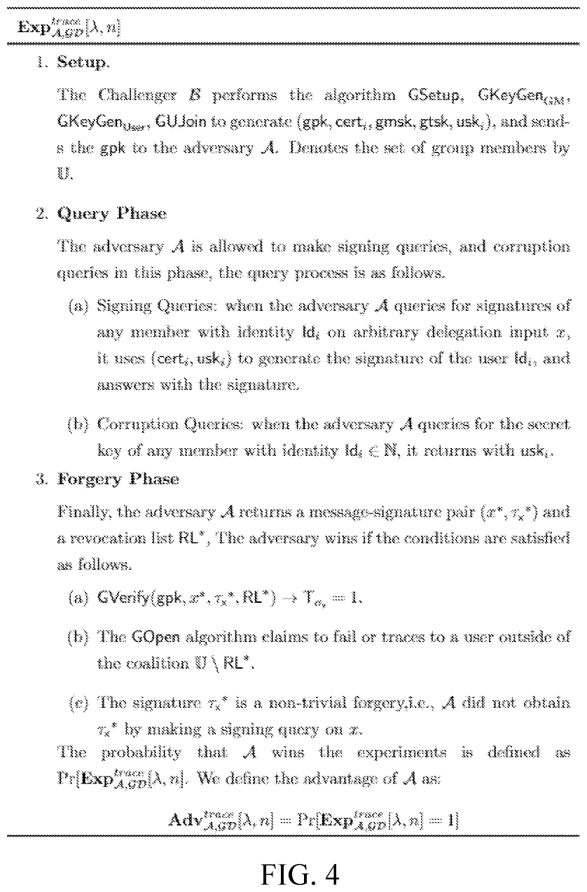

In this embodiment, Before defining traceability in detail, experiment 3 between the adversary [symbol] and the challenger [symbol] is introduced (shown in FIG. 4). In the experiment, the goal of the adversary [symbol] is to use the GOpen algorithm to forge a signature that could not be traced to a specific group member. Finally, the adversary [symbol] outputs a forged message signature pair (x*, τₓ*) and a revocation list RL*. The advantage probability of the adversary [symbol] is expressed as follows:

$${Adv}_{𝒜 , 𝒢𝒟}^{trace} [ λ , n ] = Pr [ {Exp}_{𝒜 , 𝒢𝒟}^{trace} [ λ , n ] = 1 ]$$

If the probability Ad [symbol] [λ, n] is negligible for any probabilistic polynomial time adversary [symbol] , the group delegation computing scheme is traceable.

Based on the same inventive concept, the present invention also provides a computer device, including: one or more processors, and a memory, configured to store one or more computer programs. The program includes program instructions, and the processor is configured to execute the program instructions stored in the memory. The processor may be a central processing unit (Central Processing Unit, CPU), or other general-purpose processors, a digital signal processor (Digital Signal Processor, DSP), an application specific integrated circuit (Application Specific Integrated Circuit, ASIC), a field-programmable gate array (Field-Programmable Gate Array, FPGA) or other programmable logic devices, discrete gate or transistor logic devices, discrete hardware components, or the like, and is the computing core and control core of a terminal and is configured to implement one or more instructions, and is specifically configured to load and execute one or more instructions in the computer storage medium to implement the above method.

It should be further noted that based on the same inventive concept, the present invention also provides a computer storage medium on which a computer program is stored, and the computer program, when executed by the processor, performs the above method. The storage medium may be any combination of one or more computer-readable mediums. The computer-readable medium may be a computer-readable signal medium or a computer-readable storage medium. The computer-readable storage medium may be, for example, but is not limited to, an electric, magnetic, optical, electromagnetic, infrared, or semi-conductive system, apparatus, or component, or any combination of the above. More specific examples (a non-exhaustive list) of the computer readable storage medium include: an electrical connection with one or more conductors, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination thereof. In the present invention, the computer-readable storage medium may be any tangible medium containing or storing a program, and the program may be used by or used in combination with an instruction execution system, an apparatus, or a device.

In the descriptions of this specification, a description of a reference term such as “an embodiment”, “an example”, or “a specific example” means that a specific feature, structure, material, or characteristic that is described with reference to the embodiment or the example is included in at least one embodiment or example of the present invention. In this specification, exemplary descriptions of the foregoing terms do not necessarily refer to the same embodiment or example. In addition, the described specific features, structures, materials, or characteristics may be combined in a proper manner in any one or more of the embodiments or examples.

The foregoing displays and describes basic principles, main features of the present disclosure and advantages of the present disclosure. A person skilled in the art may understand that the present disclosure is not limited to the foregoing embodiments. Descriptions in the embodiments and this specification only illustrate the principles of the present disclosure. Various modifications and improvements are made in the present disclosure without departing from the spirit and the scope of the present disclosure, and these modifications and improvements shall fall within the protection scope of the present disclosure.

1. A group delegation computing method, wherein the method comprises the following steps:
receiving a security parameter and a number of group members, and inputting the security parameter and the number of group members into a pre-established trusted third-party operation initialization algorithm model, to obtain a public parameter and an initialized revocation list;
inputting the public parameter and a delegation function into a pre-established key generation algorithm model, to obtain a group administrator secret key, a group administrator public key, a trace secret key, a trace public key, a pair of a public key and a secret key of a group member, a group public key, a secret key for delegation computing, and a public key for delegation computing;
inputting the public parameter, the group administrator secret key, and the group public key into a pre-established member joining algorithm model, generating a digital signature by using a key pair registered in PKI, verifying whether the digital signature is registered, and if the digital signature is registered, terminating joining, or if the digital signature is not registered, computing a revocation token and a group member certificate;
inputting a delegation public key, a delegation secret key, the group public key, a group member secret key, a group member certificate, and a delegation input into a pre-established question generation algorithm model, to obtain an encrypted delegation input, a verification key, a computing key, a recovery key, and a group signature issued by a group member;
inputting the group public key, the revocation list, the delegation input, and the group signature into a pre-established signature verification algorithm model, performing signature verification on the group signature issued by the group member, to output a verification result, and if the signature is legal, returning 1, or if the signature is illegal, returning 0;
inputting the computing key, the encrypted delegation input, and the verification result into a computing algorithm model, and if the signature verification is illegal, skipping performing computing, or if the signature verification is legal, computing, by the cloud server, a computing result and a correctness proof;
inputting the delegation public key, the verification key, the computing result, and the correctness proof into a pre-established blind verification algorithm model, to obtain a blind verification result, and if the computing result is correct, returning acceptance, or if the computing result is incorrect, returning rejection;
inputting the recovery key, the blind verification result, and the computing result into a pre-established recovery algorithm model, and if an output of the blind verification result is acceptance, outputting a real function result, or if the output is rejection, terminating the algorithm;
inputting the group public key, the group administrator secret key, a revocation token of a group member, and a revocation list into a pre-established member revocation algorithm model, adding the revocation token of the group member to the revocation list to perform a revocation function of the group member, and if the revocation succeeds, returning 1, or if the revocation fails, returning 0; and
inputting the group public key, a trace key, the delegation input, and the group signature into a pre-established signature opening algorithm model, to obtain an opening result, and determining an identity of a specific member of the delegation computing.

2. The group delegation computing method according to claim 1, wherein the trusted third-party operation initialization algorithm model inputs the security parameter λ∈ [symbol] , the number n∈ [symbol] of group members, outputs the public parameter pp, and initializes the revocation list to RL; the group administrator and the group member execute the key generation algorithm model and output the group administrator secret key gmsk, the trace secret key gtsk, the group administrator public key gmpk, the trace public key gtpk, a pair (uskᵢ, upkᵢ) of a public key and a secret key of a group member i, a group public key gpk:=(pp, gmpk, gtpk, upkᵢ), the public key PK_{F} for delegation computing, and the secret key SK_{F} for delegation computing; the group administrator executes the member joining algorithm model and outputs a member certificate certᵢ and a revocation token regᵢ of the group member i; the group member executes the question generation algorithm model and outputs a group signature τₓ; an encryption delegation input σₓ, a verification key VKₓ, a computing key CK_{F} of the cloud server, and a recovery key RK_{F}; the verifier executes the signature verification algorithm and outputs a signature verification result T indicating whether the group signature is legal; the cloud service provider executes the computing algorithm model when the signature verification is legal, and outputs the computing result σ_{y} and the correctness proof π; and any third party executes the blind verification algorithm model and outputs a blind verification result T_{σy} indicating whether the computing result of the cloud service provider is correct.

3. The group delegation computing method according to claim 1, wherein a process of outputting different results by the recovery algorithm model according to different blind verification results is as follows:
inputting the delegation public key PK_{F}, the verification key VKₓ, the computing result σ_{y}, and the correctness proof π, and if the blind verification result T_{σy}=(1, accept, S), outputting a real computing result y=F (x), or if the blind verification result T_{σy}=(1, reject, S), outputting ⊥.

4. The group delegation computing method according to claim 1, wherein a process of executing the member revocation algorithm by the group administrator is as follows:
the group administrator inputs the group public key gpk, the group administrator secret key gmsk, the group member revocation token regᵢ, and the revocation list RL, and adds the revocation token to the revocation list RL, updates and publishes the revocation list comprising regᵢ, and if the revocation succeeds, outputs 1, or if the revocation fails, outputs 0.

5. The group delegation computing method according to claim 1, wherein a process of executing the signature opening algorithm model and outputting different results by the group administrator is as follows:
inputting the group public key gpk, the group administrator secret key gmsk, the delegation input x, and the group signature τₓ; and if the signature is opened successfully, outputting a specific identity of a delegator, or if the signature is opened unsuccessfully, outputting ⊥.

6. The group delegation computing method according to claim 1, wherein the group delegation computing method satisfies the correctness as follows:
for ∀F∈ [symbol] , ∀x∈Dom(F) and ∀λ, n∈ [symbol] , i∈[n], both of the following conditions are true:
1) if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GUJoin(pp, gmsk, gpk)→(certᵢ, regᵢ), and GProbGen(PK_{F}, SK_{F}, gpk, uskᵢ, certᵢ, x)→(σₓ, τₓ, VKₓ, CK_{F}, RK_{F}), GVerify(gpk, x, τₓ)→T=1 and GOpen(gpk, gtsk, x, τₓ)→i are true, and this indicates that a signature generated by a legal group member by executing the signature algorithm needs to be correctly verified and opened; and
2) if it is satisfied that GSetup(1^{λ}, 1ⁿ)→pp, GKeyGen(pp, F)→{(gmsk, gmpk, gtpk, gtsk), (uskᵢ, upkᵢ, gpk), (PK_{F}, SK_{F})}, GProbGen(PK_{F}, SK_{F}, gpk, uskᵢ, certᵢ, x)→(σₓ, τₓ, VKₓ, CK_{F}, RK_{F}), and GCompute(CK_{F}, σₓ)→(σ_{y}, π), Pr[BVerify(PK_{F}, VKₓ, σ_{y}, π)→T_{σ}_{_{y}}=(1, accept, S)]=1 is true, and this indicates that if the cloud service provider performs the GCompute algorithm honestly, the verification algorithm returns acceptance at the probability 1.

7. The group delegation computing method according to claim 6, wherein the group delegation computing method satisfies verifiability as follows:
a dishonest cloud service provider or a malicious adversary cannot forge an incorrect result that can pass the blind verification algorithm, and cannot trick a user and a verifier into accepting an incorrect computing result.

8. The group delegation computing method according to claim 6, wherein the group delegation computing method satisfies anonymity as follows:
it is required that when a group signature is provided, no one other than the group administrator [symbol] can determine a real identity of a signer only based on the signature.

9. The group delegation computing method according to claim 6, wherein the group delegation computing method satisfies traceability as follows:
if the verifier has dispute over the reliability of the signature, the group administrator searches a storage list through the signature opening algorithm, to find identity information of the signer.

10. A device, comprising:
one or more processors; and
a memory, configured to store one or more programs; wherein
the one or more programs, when executed by the one or more processors, cause the one or more processors to implement the group delegation computing method according to claim 1.
